(19) United States
(12) Patent Application Publication
(10) Pub. No.: US 2023/0018593 A1
(43) Pub. Date: Jan. 19, 2023

(54) A KIND OF LIGHT-TRANSPARENT ARTIFICIAL LEATHER AND A PREPARATION METHOD THEREFOR, AND AN AUTOMOTIVE INTERIOR

(71) Applicant: Canadian General-Tower (Changshu) Co., Ltd, Changshu, Jiangsu (CN)

(72) Inventors: Qiang Guo, Changshu, Jiangsu (CN); Weifeng Song, Changshu, Jiangsu (CN); Hao Cheng, Changshu, Jiangsu (CN); Jianhong Liu, Changshu, Jiangsu (CN)

(21) Appl. No.: 17/281,320

(22) PCT Filed: Mar. 30, 2020
(86) PCT No.: PCT/CN2020/082144

§ 371 Date: Mar. 30, 2021

(30) Foreign Application Priority Data
Mar. 30, 2020 (CN) 202010239503.X

(51) Int. Cl. D06N 3/00; D06N 3/06; D06N 3/04

(52) U.S. Cl. CPC D06N 3/0059; D06N 3/06; D06N 3/042; D06N 3/045; D06N 3/0065; D06N 2209/0861

(57) ABSTRACT

A preparation method for producing a light-transparent artificial leather comprises the steps of: mixing, stirring, grinding, filtering and defoaming primary raw materials, including toner with a particle size of 0.5˜10 nm, polymer powder and a plasticizer, to produce a light-transparent pigment; mixing the light-transparent pigment with secondary raw materials, including polymer powder, a plasticizer, a stabilizer and an inorganic additive, and stirring, grinding, filtering and defoaming the mixture to produce a light-transparent epidermal layer material; mixing a base fabric, glue and a support layer material with the epidermal layer material and making the mixture into a semi-finished artificial leather product, which comprises the light-transparent epidermal layer, a support layer, a glue layer and a base fabric; and applying a surface treating agent on to the surface of the light-transparent epidermal layer to produce a light-transparent artificial leather (e.g., for an automobile interior).

### TECHNICAL FIELD

The invention relates to the technical field of artificial leather, in particular to a light-transparent artificial leather and a preparation method therefor, and an incorporation thereof in an automotive interior

### BACKGROUND ART

Artificial leather is a plastic product that looks and feels like leather and can replace leather. Characterized by high flexibility and wear resistance, artificial leather can be widely used for bag production and automotive interior decoration.

With the development of the automotive interior industry, people have increasingly high requirements for the automotive interior atmosphere and human-vehicle interactions. Owing to its unique material characteristics, the traditional artificial leather has a blocking effect on light and therefore cannot let light pass through, such that holes have to be punched in the surface for better interior transmittance. This has the results that, the cost of vehicle design is increased, and the mechanical properties of the product are reduced in the punching process, affecting the service life and application scope of the product.

### SUMMARY OF THE INVENTION

Based on the above present situation, the main aim of the invention is to provide a kind of light-transparent artificial leather and a preparation method therefor, and an automotive interior, to solve the existing problem of artificial leather.

To achieve the above aim, the invention adopts the following technical scheme:

In a first aspect, the invention is a method for producing (preparation method) light-transparent artificial leather, and said preparation method comprises the steps of:

S100: Mixing, stirring, grinding, filtering and defoaming primary raw materials, including toner with a particle size of 0.5˜10 nm, polymer powder and a plasticizer, to produce a light-transparent pigment; mixing the light-transparent pigment with secondary raw materials,; mixture, and stirring, grinding, filtering and defoaming said mixture to obtain a light-transparent epidermal layer material

S200: Mixing a base fabric, glue and a support layer material with the aforesaid light-transparent epidermal layer material and making them into a semi-finished artificial leather product which comprises a light-transparent epidermal layer, a support layer, a glue layer and a base fabric, which are arranged in the appropriate order; and

S300: Applying a surface treating agent on the surface of the light-transparent epidermal layer to produce a light-transparent artificial leather.

Wherein, in S100, the particle size of the toner in the light-transparent epidermal layer material is set to 0.5˜10 nm, e.g., any of 0.5 nm, 1 nm, 1.5 nm, 2 nm, 2.5 nm, 3 nm, 3.5 nm, 4 nm, 4.5 nm, 5 nm, 5.5 nm, 6 nm, 6.5 nm, 7 nm, 7.5 nm, 8 nm, 8.5 nm, 9 nm, 9.5 nm and 10 nm.

The main reason for the poor transmittance of artificial leather is that the epidermal layer is a colored layer and has a great blocking effect on light, but if the dosage of the pigment is reduced, the color covering effect will be very poor. In embodiments of the invention, the toner in the light-transparent epidermal layer material is a toner having a Nano-particle size, which has a lower blocking effect on light, and can ensure ideal transmittance (of light) of the prepared artificial leather even if a large quantity of toner has to be used for a good color covering effect.

In the preparation process of a conventional prior art epidermal layer material, normally, various types of powder are directly mixed together and stirred. Since the toner utilized in the invention is Nano-sized, and therefore much tinier than other powders, uneven dispersion will be caused if it is mixed with other powders. In embodiments of the invention, the toner is made into a light-transparent pigment material first, and then the light-transparent pigment material is mixed with polymer powder, a plasticizer, a stabilizer and an inorganic additive to produce a light-transparent epidermal layer material so as to greatly enhance the dispersible uniformity of the toner. In addition, the toner can be mixed with the polymer powder and plasticizer to form a light-transparent pigment material so as to greatly enhance the degree of fusion between the light-transparent pigment material and other powders. A grinding process is added to the preparation process of the light-transparent pigment material so that the toner can be mixed evenly with other powders to prevent agglomeration.

Preferably, the mass ratio of each element in the primary raw materials is as follows: 70˜100 portions of toner, for example, 70, 75, 80, 85, 90, 95 or 100 portions; 70˜100 portions of polymer powder, for example, 70, 75, 80, 85, 90, 95 or 100 portions; 70˜100 portions of plasticizer, for example, 70, 75, 80, 85, 90, 95 or 100 portions.

In the light-transparent pigment material, the content of the toner cannot be too high or too low, because excessively high content affects transmittance of the artificial leather while excessively low content affects the color covering effect, so preferably, the mass ratio of the toner in the light-transparent pigment material is set to approximately 37%-40%.

In a preferred embodiment of the invention, in the light-transparent pigment material, the toner comprises organic toner and/or inorganic toner; the organic toner is a kind of permanent red, scarlet, everbright red, everbright fast red, Lithol scarlet/magenta/dark red/ruby/purplish red, lake red, rubber scarlet, lightfast pink lake, cherry-red, quinacridone red, permanent pink, permanent ruby, permanent orange, permanent Jaffa orange, everbright fast yellow, benzidine yellow, permanent yellow, pigment fast rose red lake, pale purple, quinacridone violet, phthalocyanine green or peacock blue lake toner; the inorganic toner is a kind of iron oxide pigment (red, yellow, green, black, orange, gray or brown), or a kind of chrome yellow toner, such as molybdate red, strontium yellow, lemon chrome yellow, medium chrome yellow, deep chrome yellow or zinc chrome yellow toner, or a kind of iron blue, ultramarine blue, chrome oxide green, pigment green or carbon black toner;

the polymer powder is one or more of the kinds of polymer powders such as one or more of the following: polyvinyl chloride (PVC) powder, chlorinated polyethylene (CPE), acrylic acid (AA), polyurethane (PU) and silica gel; and

the plasticizer is made of an o-benzene material, such as dioctyl phthalate (DOP), diisononyl phthalate (DINP), phthalate, 911 or V124.

In a preferred embodiment of the invention, the preparation process of the light-transparent pigment material comprises the steps of:

S111: Combining the toner, polymer powder and plasticizer and dispersive mixing thereof to produce raw material i;

S112: Grinding the raw material i produced by S111 to produce raw material ii;

S113: Sieving the raw material ii produced by S112 to produce raw material iii; and

S114: Stirring the raw material iii produced by S113 for vacuum defoamation to produce the light-transparent pigment.

In a preferred embodiment of the invention, in S111, dispersive mixing is performed at 800˜1000 rpm, for example, at 800 rpm, 850 rpm, 900 rpm, 950 rpm or 1000 rpm. Moreover, dispersive mixing is performed for 0.5˜2 hours, for example, for 0.5 hour, 1 hour, 1.5 hours or 2 hours;

in S112, grinding is performed for 0.5˜2 hours, for example, for 0.5 hour, 1 hour, 1.5 hours or 2 hours;

in S113, the sieve consists of 120˜150 meshes, for example, 120, 125, 130, 135, 140, 145 or 150 meshes; and

in S114, vacuum defoamation stirring is performed under −0.5˜−0.1 MPa at 250˜350 rpm, for example, under −0.5 MPa, −0.4 MPa, −0.3 MPa, −0.2 MPa or −0.1 MPa at 250 rpm, 260 rpm, 270 rpm, 280 rpm, 290 rpm, 300 rpm, 310 rpm, 320 rpm, 330 rpm, 340 rpm or 350rpm. The stirring duration can be set to 20-40 minutes, for example, 20, 25, 30, 35 or 40 minutes.

Preferably, in the secondary raw materials, the mass ratio of each element is as follows: 80˜100 portions of polymer powder, for example, 80, 85, 90, 95 or 100 portions; 70˜80 portions of plasticizer, for example, 70, 72, 74, 76, 78 or 80 portions; 1˜4 portions of heat stabilizer, for example, 1, 2, 3 or 4 portions; 5˜7 portions of 5, 6 or 7 portions; 3˜5 portions of light-transparent pigment material, for example, 3, 4 or 5 servings portions.

In a preferred embodiment of the invention, in the secondary raw materials, the polymer powder is one or more kinds of polymer powders such as one or more of the following: polyvinyl chloride (PVC) powder, chlorinated polyethylene (CPE), acrylic acid (AA), polyurethane (PU) and silica gel;

the plasticizer is an o-benzene plasticizer or an ester succinate plasticizer or made of a mixture thereof; the plasticizer is made of an o-benzene material, such as dioctyl phthalate (DOP), diisononyl phthalate (DINP), phthalate, 911 or V124.

the heat stabilizer is a metal soap heat stabilizer, for example, an organic tin stabilizer, a compound lead stabilizer, a Ba—Zn composite stabilizer or Ca—Zn composite stabilizer, preferably made of calcium stearate or zinc stearate; and

the inorganic additive is one or more kinds of inorganic additive such as one or more of the following: light calcium carbonate, ground calcium carbonate, super-fine calcium carbonate, super-fine barium sulfate and fly ash.

In the prior art, all stabilizers used for the preparation of artificial leather are powder, which affects the permeability of such prior art artificial leather, therefore in a preferred embodiment of the present invention, a liquid stabilizer is used so as to further improve the transmittance of the prepared light-transparent artificial leather.

In a preferred embodiment of the invention, the preparation process of the light-transparent epidermal layer material comprises the steps of:

S121: Combining the polymer powder, plasticizer, stabilizer, inorganic additive and light-transparent pigment and dispersive mixing thereof at a gradually increasing speed to produce raw material I;

S122: Sieving raw material I produced by S121 to produce raw material II; and

S123: Stirring the raw material II produced by S122 for vacuum defoamation to produce the light-transparent epidermal layer material.

In a preferred embodiment of the invention, in S121, dispersive mixing is performed under the condition of a gradually increasing speed as follows:

dispersive mixing is performed at 400˜600 rpm for 15˜25 minutes, for example, 15, 18, 20, 23 or 25 minutes;

dispersive mixing is performed at 800˜1200 rpm for 15˜25 minutes, or example, 15, 18, 20, 23 or 25 minutes; and

dispersive mixing is performed at 2000˜3000 rpm for 15˜25 minutes, or example, 15, 18, 20, 23 or 25 minutes.

In a preferred embodiment of the invention, in S122, the sieve consists of 120˜150 meshes, for example, 120, 125, 130, 135,140, 145 or 150 meshes; and

in S123, vacuum defoamation stirring is performed under −0.5˜−0.1 MPa at 250˜350 rpm, for example, −0.5 MPa, −0.4 MPa, −0.3 MPa, −0.2 MPa, −0.1 MPa, 250 rpm, 260 rpm, 270 rpm, 280 rpm, 290 rpm, 300 rpm, 310 rpm, 320 rpm, 330 rpm, 340 rpm or 350rpm. The stirring duration can be set to 20˜40 minutes, such as 20, 25, 30, 35 or 40 minutes.

In a preferred embodiment of the invention, the support layer is not processed by a foaming technology or is merely processed by micro-foaming technology, and that the micro-foaming ratio is less than or equal to 1.5.

In a preferred embodiment of the invention, the preparation process also comprises a step of forming a light-shielding layer, such that in the step of light-shielding layer formation, the light-shielding layer is formed between the light-transparent epidermal layer and the support layer, and such that the light-shielding layer is a hollowed-out structure to form a pattern.

In a second aspect, the invention is a light-transparent artificial leather, which is prepared by the preparation method described herein.

In a third aspect, the invention is an automotive interior incorporating the light-transparent artificial leather.

### DESCRIPTION OF THE DRAWINGS

The preferred embodiments of the invention will be described as follows by reference to the drawings. In the drawings:

FIG. 1 shows a flow chart of the method for the preparation of the light-transparent artificial leather, in accordance with an embodiment of the invention;

FIG. 2 shows a structure diagram of the light-transparent artificial leather, of an embodiment of the invention.

In the drawings, the following element are denoted by the following reference numbers: the surface treating agent layer 100; the light-transparent epidermal layer 200; the support layer 300; the glue layer 400; the base fabric 500.

### DETAILED DESCRIPTION OF THE INVENTION

The invention is described below based on some of its embodiments, but there are more embodiments of the invention than are enumerated herein. In the description of the details of the invention herein, some specific details are described in detail. To avoid confusion regarding the essence of the invention, the methods, processes, procedures or components well known in the art are not described in detail herein.

In addition, those of ordinary skill in the art will recognize that all of the drawings provided herein are for illustrative purposes only, and that the drawings are not necessarily drawn to scale.

Unless explicitly stated in the context, the terms “contain” and “include”, as well as similar words and phrases, herein should be interpreted as inclusive terms rather than exclusive or exhaustive terms; in other words, these terms, as well as similar words and phrases, mean “including but not limited to”.

In the description of the invention, it should be understood that the terms “first” and “second” are applied for descriptive purposes only and do not indicate or imply relative importance. Moreover, in the description of the invention, “a number of” “multiple” and “plurality” mean two or more.

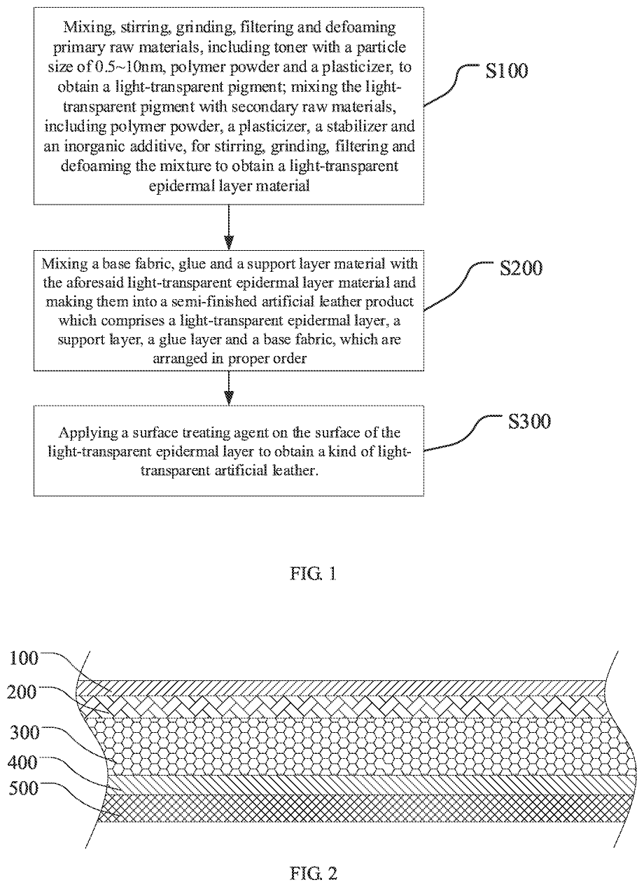

In regards to the problem of poor transmittance of the existing prior art artificial leather, the invention overcomes said problem by providing a method for the preparation of light-transparent artificial leather. As shown in FIG. 1, said preparation method comprises the steps of:

S100: Mixing, stirring, grinding, filtering and defoaming primary raw materials, including toner with a particle size of 0.5˜10 nm, polymer powder and a plasticizer, to produce a light-transparent pigment; mixing the light-transparent pigment with secondary raw materials, including polymer powder, a plasticizer, a stabilizer and an inorganic additive to produce a mixture, and stirring, grinding, filtering and defoaming said mixture to obtain a light-transparent epidermal layer material;

S200: Mixing a base fabric, glue and a support layer material with the light-transparent epidermal layer material and making them into a semi-finished artificial leather product which comprises a light-transparent epidermal layer, a support layer, a glue layer and a base fabric, which are arranged in an appropriate order; and

S300: Applying a surface treating agent on the surface of the light-transparent epidermal layer to produce a light-transparent artificial leather.

The support layer comprises virtually the same materials as the light-transparent epidermal layer, and the only difference therebetween is that there is toner incorporated in the support layer. The support layer of conventional prior art artificial leather is a foaming structure. Because foaming affects the transmittance of artificial leather, in a preferred embodiment of the invention, the support layer is not processed by foaming technology or is merely processed by micro-foaming technology, and such micro-foaming ratio is less than or equal to 1.5. If the support layer does not undergo a foaming process, there will be no foaming agent in the raw materials of the support layer; if the support layer undergoes a foaming process, there will be a small amount of foaming agent in the raw materials of the support layer such that the foaming ratio may be less than or equal to 1.5. In S200, each layer structure can be formed by a release paper coating method or a calendering method (both such methods are incorporated herein by reference). The glue therein may be transparent glue or glue layer slurry made from polymer powder, or some other type of glue. In an embodiment of the invention, wherein transparent glue is used, if the release paper coating method is adopted (the raw material is slurry), the preparation process comprises the following steps of:

applying light-transparent epidermal layer slurry on to release paper to form a light-transparent epidermal layer;

applying support layer slurry on the light-transparent epidermal layer to form a support layer;

applying transparent glue on the support layer and cladding it with a base fabric;

separating each layer formed from the release paper, and

then proceeding to S300 to produce a light-transparent artificial leather.

In an embodiment of the invention wherein the calendering method is adopted (the raw material is powder), the preparation method of the invention comprises the following steps of:

calendering the support layer powder to form a support layer;

calendering the light-transparent epidermal layer powder on the support layer to form a light-transparent epidermal layer;

applying transparent glue on the support layer and cladding it with a base fabric; and processing each layer formed in accordance with S300 to produce a light-transparent artificial leather.

The surface treating agent comprises water-borne polyurethane (WPU) and water-based color paste. Owing to the low thickness of the surface treating agent layer, which therefore has little impact on transmittance, to save costs, a kind of toner with a regular particle size, such as a particle size of 1˜5 um, is can be added to the water-based color paste. In addition, the surface treating agent layer may be processed by an embossing technology (which is incorporated herein by reference).

In an embodiment of the invention, wherein the raw material of glue is a type of glue layer slurry, the glue layer material also forms a glue layer and is affixed to the support layer, while the other side of the glue layer is covered with a base fabric. The base fabric can be a knitted fabric, non-woven fabric, three-dimensional spaced fabric or light-transparent polyurethane foam substrate. Similarly, in S200, each layer structure can be formed by a release paper coating method or a calendering method, for example, if the release paper coating method is applied (the raw material is slurry), the preparation method of the invention comprises the following steps of:

applying light-transparent epidermal layer slurry on to release paper to form a light-transparent epidermal layer;

applying support layer slurry on the light-transparent epidermal layer to form a support layer;

applying glue layer slurry on the support layer to form a glue layer; and

pasting a base fabric to the glue layer, separating each layer formed from the release paper, and then proceeding to S300 to produce a light-transparent artificial leather.

In another embodiment of the invention, if the calendering method is applied (only the glue layer material is slurry, while the raw materials of other layers are powder), the preparation method of the invention comprises the following steps of:

applying glue layer slurry on to the base fabric to form a glue layer;

calendering the support layer powder on the glue layer to form a support layer;

calendering the light-transparent epidermal layer powder on the support layer to form a light-transparent epidermal layer; and

then, processing each layer formed in accordance with S300 to produce light-transparent artificial leather.

The structure of the light-transparent artificial leather prepared by a preparation method of the invention disclosed herein is shown in FIG. 2. Said light-transparent artificial leather comprises a surface treating agent layer 100, light-transparent epidermal layer 200, support layer 300, glue layer 400 and base fabric 500, which are arranged layer upon layer in an appropriate order.

For an item covered in the light-transparent artificial leather prepared by the preparation method disclosed herein, light may transmit through the light-entire transparent artificial leather. However, in some application scenarios, it is necessary to present a pattern with decorative effects or an indication of functions on the surface of the light-transparent artificial leather. Based on this, in a preferred embodiment of the invention, the preparation method also comprises a step of forming a light-shielding layer, comprising a step of light-shielding layer formation, whereby the light-shielding layer is formed between the light-transparent epidermal layer and the support layer, and the light-shielding layer is a hollowed-out structure to form a pattern. In this manner, the light-transparent artificial leather, when the light is off, will look normal, but when the light is on, there will be a visible pattern on the surface of the light-transparent artificial leather. Such an embodiment of the invention has several benefits, for example, there is no requirement for the light source to have any particular shape, i.e., there is no need to shape the light source in a specific manner As an additional benefit, after the light-shielding layer is incorporated in the light-transparent artificial leather, the light-shielding layer will be very close to the surface of the light-transparent artificial leather, and there will be virtually no light scattering caused, thus the pattern is made quite clearly discernible and visible. The clarity of the pattern won't be affected even if the light-transparent artificial leather is affixed to a three-dimensional spacer fabric to form a composite structure. As a further additional benefit, the light-shielding layer can be prevented from making contact with other structures, with the result that the light-shielding layer may be well protected. Compared with a method of providing a light-shielding layer on the outer side of the light-transparent artificial leather, this arrangement method may effectively protect the light-shielding layer from falling off or being destroyed by other structures bonded to it.

In embodiments of the present invention, the light-shielding layer can be glued to the light-transparent epidermal layer and support layer after preparation thereof. In order that the light-shielding should be better glued to the material layer, in a preferred embodiment of the invention, the light-shielding can be printed on the surface of the light-transparent epidermal layer or support layer. For example, in an embodiment of the invention wherein the release paper coating method is applied, the light-shielding can be printed on the surface of the light-transparent epidermal layer and then coated with support layer slurry to form a support layer. In an embodiment of the invention wherein the calendering method is applied, the light-shielding can be printed on the surface of the support layer and then coated with light-transparent epidermal layer powder to form a light-transparent epidermal layer by calendering. The printing method may be one of many kinds of printing methods such as one or more of the following: UV printing, gravure printing, heat transfer process and screen printing. The printing method may comprise a simple process, such as one or more of multi-color gradient and true-color displaying. UV printing is particularly suitable for the printing of a light-shielding layer comprising a light-transmitting structure.

The light-transparent artificial leather prepared by the preparation method of the invention can be used as part of or incorporated within an automotive interior.

Specific embodiments of the preparation method of the invention include those described as follows:

### Embodiment 1

(1) Preparation of light-transparent pigment slurry, comprising the steps of: combining 100 portions of Nano-sized toner, 100 portions of PVC powder and 100 portions of DMP and mixing such combination for 1-hour by dispersive mixing at 1,000rpm; grinding said well-mixed slurry in a grinder for 1 hour; filtering said slurry in a sieve with 150 meshes, and then stirring it under −0.1 MPa at 300 rpm for 30 minutes for vacuum defoamation to produce a light-transparent pigment slurry;

(2) Preparation of light-transparent epidermal layer slurry, comprising the steps of: combining 100 portions of PVC powder, 70 portions of plasticizer DOP, 1 portion of heat stabilizer calcium stearate, 2 portions of heat stabilizer zinc stearate, 5 portions of calcium carbonate and 4 portions of the light-transparent pigment slurry produced by Step (1) and mixing such combination for 20-minutes by dispersive mixing at 500rpm; then mixing for 20-minutes by dispersive mixing at 1,000 rpm; then mixing for 20-minutes by dispersive mixing at 2,500 rpm; filtering the well-mixed slurry in a sieve with 150 meshes, and then stirring it under −0.1 MPa at 300 rpm for 30 minutes for vacuum defoamation to produce a light-transparent epidermal layer slurry; and

(3) Preparation of light-transparent artificial leather, comprising the steps of: mixing the base fabric, glue layer slurry, support layer slurry and light-transparent epidermal layer slurry together in an appropriate order to produce a semi-finished light-transparent artificial leather by a release paper coating method; then, applying a surface treating agent on to the semi-finished light-transparent artificial leather and calendering it to produce a light-transparent artificial leather.

### Embodiment 2

(1) Preparation of light-transparent pigment slurry, comprising the steps of: combining 100 portions of Nano-sized toner, 90 portions of PVC powder and 90 portions of DMP and mixing said combination for 1-hour by dispersive mixing at 1000 rpm; grinding the well-mixed slurry in a grinder for 1 hour; filtering the slurry in a sieve with 150 meshes, and then stirring it under −0.1 MPa at 300 rpm for 30 minutes for vacuum defoamation to produce a light-transparent pigment slurry;

(2) Preparation of light-transparent epidermal layer slurry, comprising the steps of: combining 100 portions of PVC powder, 70 portions of plasticizer DOP, 1 portion of heat stabilizer zinc stearate, 7 portions of calcium carbonate and 1 portion of the light-transparent pigment slurry produced by Step (1) and mixing said combination for 20-minutes by dispersive mixing at 500 rpm; then mixing for 40-minutes by dispersive mixing at 800 rpm; then mixing for 35-minutes by dispersive mixing at 2,600 rpm; filtering the well-mixed slurry in a sieve with 150 meshes, and then stirring it under −0.1 MPa at 400 rpm for 20 minutes for vacuum defoamation to produce a light-transparent epidermal layer slurry; and

(3) Preparation of light-transparent artificial leather, comprising the steps of: mixing the base fabric, glue layer slurry, support layer slurry and light-transparent epidermal layer slurry together in an appropriate order to produce a semi-finished light-transparent artificial leather by a release paper coating method; then, applying a surface treating agent on to the semi-finished light-transparent artificial leather and calendering it to produce a light-transparent artificial leather.

### Embodiment 3

(1) Preparation of light-transparent pigment slurry, comprising the steps of: combining 100 portions of Nano-sized toner, 80 portions of PVC powder and 80 portions of n-butyl phthalate and mixing said combination for 1-hour by dispersive mixing at 1,000 rpm; grinding the well-mixed slurry in a grinder for 1 hour; filtering the slurry in a sieve with 150 meshes, and then stirring it under −0.1 MPa at 300 rpm for 30 minutes for vacuum defoamation to produce a light-transparent pigment slurry;

(2) Preparation of light-transparent epidermal layer slurry, comprising the steps of:

combining 100 portions of PVC powder, 70 portions of plasticizer DOP, 1 portion of heat stabilizer zinc stearate, 5 portions of calcium carbonate and 4 portions of the light-transparent pigment slurry produced by Step (1) and mixing said combination for 20-minutes by dispersive mixing at 500 rpm; then mixing for 40-minutes by dispersive mixing at 800 rpm; then mixing for 35-minutes by dispersive mixing at 2,600 rpm; filtering the well-mixed slurry in a sieve with 150 meshes, and then stirring it under −0.1 MPa at 400 rpm for 20 minutes for vacuum defoamation to produce a light-transparent epidermal layer slurry; and

(3) Preparation of light-transparent artificial leather, comprising the steps of: mixing the base fabric, glue layer slurry, support layer slurry and light-transparent epidermal layer slurry together in an appropriate order to prepare a semi-finished light-transparent artificial leather by a release paper coating method; then, applying a surface treating agent on to the semi-finished light-transparent artificial leather and calendering it to produce a light-transparent artificial leather.

### Embodiment 4

(1) Preparation of light-transparent pigment slurry, comprising the steps of: combining 100 portions of Nano-sized toner, 70 portions of PVC powder and 70 portions of n-butyl phthalate and mixing said combination for 1-hour by dispersive mixing at 1,000 rpm; grinding the well-mixed slurry in a grinder for 1 hour; filtering the slurry in a sieve with 150 meshes, and then stirring it under −0.1 MPa at 300 rpm for 30 minutes for vacuum defoamation to produce a light-transparent pigment slurry;

(2) Preparation of light-transparent epidermal layer slurry, comprising the steps of: combining 100 portions of PVC powder, 70 portions of plasticizer DOP, 1 portion of heat stabilizer zinc stearate, 7 portions of calcium carbonate and 4 portions of the light-transparent pigment slurry produced by Step (1) and mixing said combination for 20-minutes by dispersive mixing at 500 rpm; then mixing for 40-minutes by dispersive mixing at 800 rpm; then mixing for 35-minutes by dispersive mixing at 2,600 rpm; filtering the well-mixed slurry in a sieve with 150 meshes, and then stirring it under −0.1 MPa at 400 rpm for 20 minutes for vacuum defoamation to produce a light-transparent epidermal layer slurry; and

(3) Preparation of light-transparent artificial leather, comprising the steps of: mixing the base fabric, glue layer slurry, support layer slurry and light-transparent epidermal layer slurry together in an appropriate order to prepare a semi-finished light-transparent artificial leather by a release paper coating method; then, applying a surface treating agent on to the semi-finished light-transparent artificial leather and calendering it to produce a light-transparent artificial leather.

### Comparative (Prior Art) Embodiment 1

The preparation process comprises the steps of: combining 3 portions of Nano-sized toner, 100 portions of vestolit powder, 70 portions of plasticizer ester succinate, 1 portion of heat stabilizer zinc stearate, 5 portions of inorganic filler calcium carbonate and 2 portions of common artificial leather pigment and mixing said combination for 20-minutes by dispersive mixing at 500 rpm; then mixing for 40-minutes by dispersive mixing at 800 rpm; then mixing for 35-minutes by dispersive mixing at 2,600 rpm; filtering the well-mixed slurry in a sieve with 150 meshes, and then stirring it under −0.1 MPa at 400 rpm for 20 minutes for vacuum defoamation to produce an epidermal layer slurry; and

Mixing the base fabric, glue layer slurry, support layer slurry and epidermal layer slurry together in an appropriate order to prepare a semi-finished artificial leather by a release paper coating method; then, applying a surface treating agent on to the semi-finished artificial leather and calendering it to produce a conventional prior art artificial leather.

### Comparative (Prior Art) Embodiment 2

(1) Preparation of pigment, comprising the steps of: combining common toner in common color, 80 portions of PVC powder, and 70 portions of n-butyl phthalate and mixing said combination for 1-hour by dispersive mixing at 1,000 rpm; grinding the well-mixed slurry in a grinder for 1 hour; filtering the slurry in a sieve with 150 meshes, and then stirring it under −0.1 MPa at 300 rpm for 30 minutes for vacuum defoamation to produce a pigment;

(2) Preparation of epidermal layer slurry, comprising the steps of: combining 100 portions of vestolit powder, 70 portions of plasticizer ester succinate, 1 portion of heat stabilizer zinc stearate, 7 portions of calcium carbonate and 2 portions of the pigment prepared by Step (1) and mixing said combination for 20-minutes by dispersive mixing at 500 rpm; then mixing for 40-minutes by dispersive mixing at 800 rpm; then mixing for 35-minutes by dispersive mixing at 2,600 rpm; filtering the well-mixed slurry in a sieve with 150 meshes, and then stirring it under −0.1MPa at 400 rpm 20 minutes for vacuum defoamation to produce a light-transparent epidermal layer slurry; and

(3) Preparation of artificial leather, comprising the steps of: mixing the base fabric, glue layer slurry, support layer slurry and light-transparent epidermal layer slurry together in an appropriate order to prepare a semi-finished artificial leather by a release paper coating method; then, applying a surface treating agent on to the semi-finished light-transparent artificial leather and calendering it to produce a prior art artificial leather product.

The products obtained Embodiment 1, Embodiment 2, Embodiment 3, Embodiment 4, Comparative Embodiment 1 and Comparative Embodiment 2 are denoted by S1, S2, S3, S4, S5 and S6, respectively. For an easy comparison, the toner in Embodiment 1, Embodiment 2, Embodiment 3, Embodiment 4 is depicted in black, and the mass ratio of the constituents of the glue layer slurry is as follows: 100 portions of PVC powder, 60 portions of plasticizer ester succinate, 2 portions of heat stabilizer zinc stearate, and 7 portions of calcium carbonate; the mass ratio of the constituents of the support layer slurry is as follows: 100 portions of PVC powder, 80 portions of plasticizer ester succinate, 1 portion of heat stabilizer zinc stearate, and 7 portions of calcium carbonate;

The transmittance of the aforesaid products is determined in accordance with ASTM E1348 (of ASTM International). The determination results of the transmittance and the visual inspection results of the color dispersing and covering effects are shown in the table below:

| | | Color Dispersing | Color |
|---|---|---|---|
| SN | Transmittance | Effect of Sample | Covering Effect |
| S1 | 19% | Even color dispersing | Non-high color |
| | | | covering effect |
| S2 | 16% | Even color dispersing | Good color |
| | | | covering effect |
| S3 | 14.3% | Even color dispersing | High color |
| | | | covering effect |
| S4 | 10% | Even color dispersing | High color |
| | | | covering effect |
| S5 | 11% | Uneven color dispersing | Good color |
| | | | covering effect |
| S6 | 0 | Even color dispersing | Good color |
| | | | covering effect |

As can be seen in the table above, Nano-sized toner can effectively improve the transmittance of artificial leather. In embodiments of the present invention, light-transparent pigment slurry is prepared, and then the light-transparent pigment slurry is mixed with other powders to prepare light-transparent epidermal layer slurry to effectively improve the dispersing effect of the toner so as to ensure the uniformity of color dispersion.

Those skilled in the art are supposed will recognize that under the premise of no contradiction, aspects of the preferred embodiments of the invention can be freely combined together or superimposed over one another.

It should be understood that the embodiments of the invention disclosed herein are exemplary embodiments only, not restrictive embodiments. Any obvious or equivalent modification or replacement of the elements or processes of the inventions as disclosed herein made by those skilled in the art without deviating from the basic principles of the invention will be included in the scope of the invention.

1. A method of producing a light-transparent artificial leather, characterized in that the method (preparation method) comprises the steps of:
mixing, stirring, grinding, filtering and defoaming primary raw materials, including a toner with a particle size of 0.5-10 nm, polymer powder and a plasticizer, to produce a light-transparent pigment;
mixing the light-transparent pigment with secondary raw materials, including polymer powder, a plasticizer, a stabilizer and an inorganic additive, to produce a mixture;
stirring, grinding, filtering and defoaming said mixture to produce a light-transparent epidermal layer material;
mixing a base fabric, glue, and a support layer material with the light-transparent epidermal layer material and making them into a semi-finished artificial leather product which comprises a light-transparent epidermal layer, a support layer, a glue layer, and a base fabric; and
applying a surface treating agent on to a surface of the light-transparent epidermal layer material to produce a light-transparent artificial leather.

2. The method of claim 1, characterized in that a mass ratio of each of the primary raw materials is as follows: 70-100 portions of toner, 70-100 portions polymer powder, and 70-100 portions of plasticizer.

3. The method of claim 1, characterized in that the primary raw materials include the following:
the toner comprises inorganic toner and/or organic toner;
the polymer powder is one or more of the following: polyvinyl chloride (PVC) powder, chlorinated polyethylene (CPE), acrylic acid (AA), polyurethane (PU) and silica gel; and
the plasticizer is an o-benzene plasticizer.

4. The method of claim 1, characterized in that it comprises the following steps for a process for producing the light-transparent pigment:
combining the toner, polymer powder and plasticizer together and mixing by dispersive mixing to produce raw material i;
grinding the raw material i to produce raw material ii;
sieving the raw material ii to produce raw material iii; and
stirring the raw material iii for vacuum defoamation to produce a light-transparent pigment.

5. The method of claim 4, characterized in that the steps include:
the dispersive mixing to produce the raw material I being performed for 0.5-2 hours at 800-1000 rpm;
the grinding being performed for 0.5-2 hours;
the sieving being performed with a sieve that consists of 120-150 meshes; and
the stirring being performed for 20-40 minutes under condition of −0.5-−0.1 MPa for vacuum defoamation.

6. The method of claim 1, characterized in that the secondary raw materials include a mass ratio of each element as follows: 80-100 portions of polymer powder, 70-80 portions of plasticizer, 1-4 portions of heat stabilizer, 5-7 portions of inorganic additive, and 3-5 portions of light-transparent pigment

7. The method of claim 1, characterized in that the secondary raw materials include the following:
the polymer powder being one or more of the following: polyvinyl chloride (PVC) powder, chlorinated polyethylene (CPE), acrylic acid (AA), polyurethane (PU) and silica gel;
the plasticizer being one or a combination of the following: an o-benzene plasticizer or an ester succinate plasticizer;
the stabilizer being a metal soap heat stabilizer; and
the inorganic additive being one or more of the following: light calcium carbonate, ground calcium carbonate, super-fine calcium carbonate, super-fine barium sulfate and fly ash.

8. The method of claim 1, characterized in that it comprises the following steps for a process for producing the light-transparent epidermal layer material:
combining the polymer powder, plasticizer, stabilizer, inorganic additive and light-transparent pigment by dispersive mixing under conditions of gradually increasing speed to produce raw material I;
sieving raw material Ito produce raw material II; and
stirring the raw material II for vacuum defoamation to produce the light-transparent epidermal layer material.

9. The method of claim 8, characterized in that the gradually increasing speed to produce raw material I includes the following sequential steps:
dispersive mixing being performed for 15-25 minutes at 400-600 rpm;
dispersive mixing being performed for 15-25 minutes at 800-1200 rpm; and
dispersive mixing being performed for 15-25 minutes at 2000-3000 rpm.

10. The method of claim 8, characterized in that:
the sieving of raw material I is performed with a sieve that consists of 120-150 meshes; and
the stirring of the raw material II for vacuum defoamation is performed for 20-40 minutes under −0.5-−0.1 MPa at 250-350 rpm.

11. The method of claim 1, characterized in that the support layer is not processed by foaming technology or is processed by micro-foaming technology having a micro-foaming ratio of less than or equal to 1.5.

12. The method of claim 1, characterized in that it comprises a step of forming a light-shielding layer, said light-shielding layer being formed between the light-transparent epidermal layer and the support layer, and a hollowed-out structure being produced on the light-shielding layer to form a pattern.

13. A light-transparent artificial leather, characterized in that it is produced by the method of claim 1.

14. An automotive interior, characterized in that it incorporates a light-transparent artificial leather of claim 13.
